(19) United States
(12) Patent Application Publication
(10) Pub. No.: US 2015/0002267 A1
(43) Pub. Date: Jan. 1, 2015

(54) HUMAN ENUMERATION AFTER DISASTERS

(71) Applicant: Curtis Roys, Kingsland, TX (US)

(72) Inventor: Curtis Roys, Kingsland, TX (US)

(21) Appl. No.: 14/321,361

(22) Filed: Jul. 1, 2014

Related U.S. Application Data
(60) Provisional application No. 61/841,749, filed on Jul. 1, 2013.

(51) Int. Cl. G06K 7/10; G08B 25/01

(52) U.S. Cl. CPC G06K 7/10009; G08B 25/016
USPC 340/5.81

(57) ABSTRACT

A method and apparatus for reporting victims of natural disasters (tornadoes, hurricanes, floods, earthquakes, etc.) or man-made disasters (explosions, fires, mass shootings, aircraft or train accidents, etc.), is disclosed. A machine-readable tag is issued to a rescue worker, first-responder, etc. The information in this tag is then uploaded to a database. During disaster relief operations, when a victim of a disaster is found, the tag is attached to the victim and then scanned by a device having geographic information, such as from GPS. An image of the victim along with the location information and possibly other information on the victim's identity and physical condition (deceased or extent of injuries) is uploaded, such as through a cell phone communications system, a satellite communication system, or other communications system, into a database. The database can be queried by family members and loved ones, as well as disaster relief personnel.

This application claims priority from U.S. Prov. Pat. App. No. 61/841,749, filed Jul. 1, 2013, which is hereby incorporated by reference.

### TECHNICAL FIELD OF THE INVENTION

The present invention relates to management and reporting of victims killed and survivors of natural or man-induced disasters.

### BACKGROUND OF THE INVENTION

All natural and man-induced disasters have several things in common, including:

A. The deceased victims are counted and documented by someone manually counting and recording their results or several people counting and documenting the victims found dead.

B. There is no accurate or quick method after a disaster to notify loved ones or family members if their family members 1. Survived the disaster, or 2. If they have been injured or if they are in a hospital under a physician's care.

The aftermath of the May 20, 2013 tornado disaster in Oklahoma City illustrates the problem of accounting for people in a disaster. An earlier death toll reported between 51 and 91, but the medical examiner said some victims may have been counted twice in the confusion. A spokesman for OU Medical Center said at one point that 85 people, including 50 children, came to his hospital and an affiliated children's hospital for treatment, but he did not know how many had been released. The country coroner said errors in the reporting of death tolls most often result from having too many people involved in the process of counting the dead victims. The final death toll wasn't available for more than a month after the tornado, and even then, the original final death toll was revised down by one person that was counted as dead, after that person was found alive elsewhere.

### SUMMARY OF THE INVENTION

An object of the invention is to provide a method of accounting for people during a natural disaster or other situation in which it is necessary to track potentially large numbers of people and their health status (deceased, injured, uninjured).

The Federal Emergency Management Agency (FEMA) or other government agency could use the invention for uniformity across the United States in reporting on victims of natural disasters (e.g., tornadoes, hurricanes, floods, earthquakes, etc.) or man-made disasters (e.g., explosions, fires, mass shootings, aircraft or train accidents, etc.). In other countries, similar governmental agencies could also use the invention for disaster reporting.

Following a disaster, either natural or man-made, a search for victims is typically conducted. In accordance with a preferred embodiment, a tag, including machine-readable coded information preferably including a unique identifier for the tag and identifying a person or group to whom the tag is issued, is issued to a person and the tag information is uploaded to a database. During this search, when a victim is found, the tag is then attached to the victim. The tag is then scanned by a device capable of determining its location, such as a smart phone having global positioning system capability. An image of the victim along with the location information and other information (such as alive or dead, condition of health, etc.) is uploaded, such as through a cell phone communications system, a satellite communication system, wireless internet connection, or other communications system, into a database.

The foregoing has outlined rather broadly the features and technical advantages of the present invention in order that the detailed description of the invention that follows may be better understood. Additional features and advantages of the invention will be described herein after. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows a flowchart of a method for tagging victims of disasters and then subsequently conveying this information to a database.

FIG. 2 shows the components of a Human Enumeration after Disaster (HEAD) system connected through a network.

FIG. 3 shows a flowchart of a method for retrieving information from victims who were tagged according to the method of FIG. 1.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

In accordance with a preferred embodiment of the invention, a disaster response coordination team provides tags with unique machine-readable identification information to rescue workers. The rescue workers attach the tag to each victim. By victim is meant not only those who were killed or injured, but also those who were present and need to be accounted for.

After the tag is attached, the rescue worker uses an electronic device, such as a mobile phone running a Rescue App, to scan the tag, reading the information on the tag, and uploading the information to a database. The information that is uploaded is a combination of information read from the tag and information determined independently of the tag. Some of the information determined independently of the tag may be information derived from the device, such as a device identifier or positional information, such as GPS coordinates, determined by the device. Some of the information can be one or more photographs captured by the device or information manually entered by the rescue worker.

The uploaded information preferably includes victim information, including one or more images of the victim formed by the electronic device and the physical location, such as using GPS coordinates, where the victim was found, and information that identifies the device that scanned the tag, and the device that took any photographs, as well as the time and location of each photograph. Other victim information can be recorded using an input device such as a keyboard or touch screen. Such information can include the name of the victim and any other information, such as the condition of the victim or a request from the victim with regard to who to contact or destination of the victim. The machine-readable information from the tag, along with the victim information, is stored in the machine and uploaded to an event database, either immediately after scanning or, if no connection is available, the information is stored in the machine for uploading later.

When a second rescue worker comes across the same victim, the second rescue worker will notice the tag and not double-count the victim. If the tag has been destroyed or removed, the photograph and the location can help to identify duplicates. When the victim is transported to a hospital or to a mortuary, the tag is scanned again and the identity and location of the scan is uploaded to the event database. Every time the victim is transported over a significant distance (i.e., a distance detectable by GPS location-finding), the tag may be scanned again and uploaded to the event database.

In some situations, the machine-readable tag may be created at a central location and distributed to rescue workers. In this case, the tag will not include any victim information, but will include a unique identifying number, and preferably other information such as an event identifier, the identity of the person or organization that was issued the tag, and the site of the tag creation. If the tag is created near the scene where the victim first comes to the attention of authorities, the tag could be created with the victim's name, if known, and the GPS coordinates of the location where the victim was found.

A preferred embodiment of the system includes a field hardware component capable of reading the machine-readable tag. For example, the field hardware could comprise a general purpose cell phone or tablet, or a device manufactured specifically for use with the invention. In some embodiments, the machine readable code may be a bar code, a QRS code, or a radio frequency identification (RFID) code embedded in a microchip, such as an RFID microchip complying with ISO 11784 or 11785. The tag includes a means for attaching the tag to a victim, such as a clip or a tie wrap that can be wrapped around a person's arm, leg, wrist, etc.

The software will upload the entity's name that placed the tag on the person, photo of the person, the person's identity (if alive or verified) and the GPS location of the person.

If the person is deceased and their identity has not been verified, a GPS location and photo taken immediately after death will enable that person to be identified by a coroner when he compares the photos supplied by families that suspect their loved ones were in the area of the disaster. In a catastrophe, it can be important to immediately photograph every deceased person to allow the person to be recognized or compared to a photo before the body decomposes.

After the tag is scanned, the device is activated to transmit the photo and information on the tag to an internet database that is maintained by an individual company or by the state, local, or federal government

### Use of the Database

In some embodiments, portions of the database can be made available to the public to provide friends and family members the ability to easily verify the condition of a person. If a person has a friend or loved one in the disaster area they can go to the website URL provided by a state, government, or local agencies, or television media, and enter the name of the person they're searching for. If the person has been tagged, their name will be on the list, along with the status of the person, that is, deceased, hospitalized, or released. If the person is in a hospital, the name and GPS location of the hospital can be available along with the person's name. If the person is in transit, the destination is identified. Now their loved ones can immediately know they are alive and/or being treated at that facility.

In some embodiments, to protect the privacy of victims, the database may be only available to emergency personnel, and friends or family would need to contact an official to search the database. In some embodiments, an official can provide a password that allows a family or friend to search the database for a specified individual or individuals. The password can control the information that is available to the searcher. For example, specific information or photographs that might be upsetting to a family might not be made available.

In some embodiments, family or friends of individual in the disaster area can upload one or more images of a potential victim. The uploaded image can be matched to photographs uploaded by emergency workers, either using image recognition software or manually. Photographs in the database can be matched with photographs from any source, such as from a pre-existing employee database, from a law enforcement database, or from a social networking database.

Various embodiment of the invention may provide some or all of the following advantages over current methods.

Embodiments eliminate mistakes caused by manual counting. All information (photo, GPS location and name, if verified) is automatically loaded in the device and uploaded to a database.

Embodiments greatly reduce or eliminate inaccurate counting of persons, whether alive or deceased. Each person is tagged, photographed, and scanned so the possibility of errors or duplications reporting deceased victims is eliminated. If any person or body is tagged then it is easily recognized by other disaster relief organizations that they have been counted.

Embodiments allow people to quickly and easily find the status of a loved one by logging into a state, local, government, or non-governmental agency-owned website and enter the name of their friend or loved ones and instantly know if they've escaped injury or are being treated in a hospital.

Embodiments allow rescue workers to use existing cell service or if there is no cell service, satellite communications.

Accurate reporting of both deceased victims and survivors in a disaster provides many advantages. People around the world have family or loved ones in areas where natural or man-induced disasters take place. No matter if it's in a metropolitan area, rural area, third world country or if there is no communication utilities available, hundreds of thousands of people can be relieved of hours, days, weeks or months of mental anguish if they can verify their friends or family members have survived and are alive and well, or if they are in a hospital being treated for their injuries.

Mistakes made by manually counting deceased victims will be eliminated, and embodiments can provide accurate documenting and/or identification of deceased victims.

Total automation for accurate reporting of survivors, killed or deceased victims to the state, local or federal government can be achieved worldwide for natural disasters, man-induced disasters or acts of war.

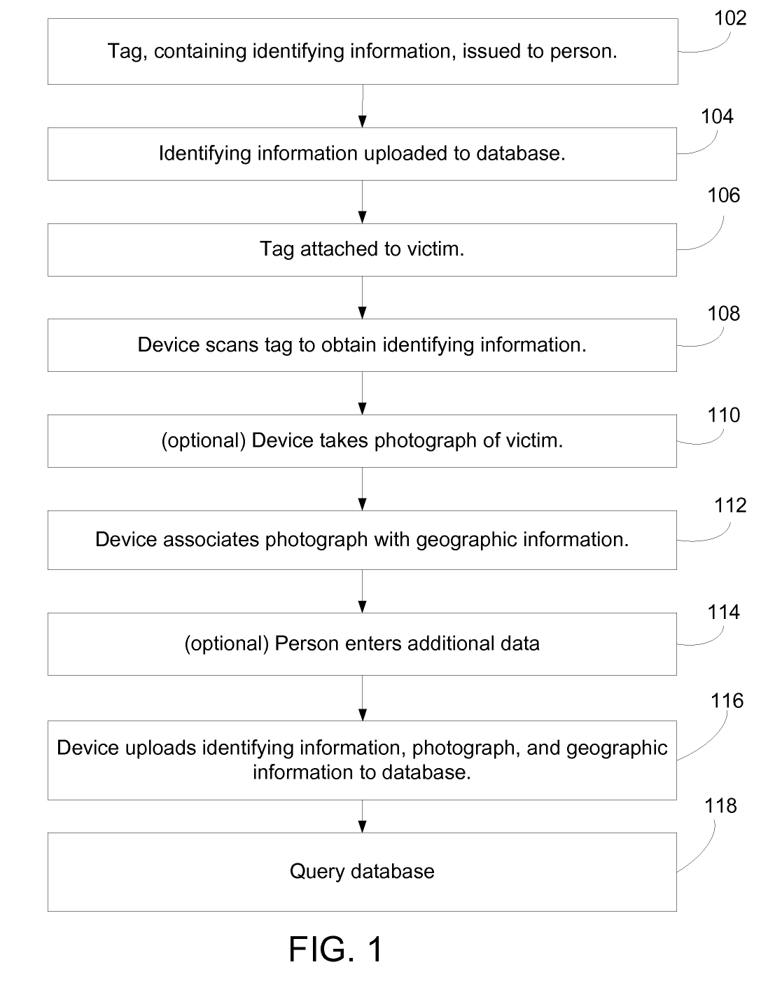

FIG. 1 shows one embodiment of the method of documenting victims in a disaster. In step 102, a tag, containing identifying information is issued to a rescue worker. The tag can be issued, for example, by a government agency or by a non-governmental agency such as the Red Cross. The term “tag” includes any machine-readable encoded information, such as a physical tag with a printed bar code or QRS code, as well as a code embedded in circuitry, such as an RFID circuit. In step 104, after the tag is issued, the identifying information corresponding to the tag is uploaded to one or more databases. When a victim is discovered, in step 106, the tag is attached to the victim, for example, using a bracelet of the type used in hospitals on patients, a plastic tie wrap, or a metal wire. In step 108, an electronic device, such as a smart phone, scans the tag to obtain the identifying information. In optional step 110, the device or smartphone also takes a photograph of the victim, and in step 112, the device associates the photograph and the geographic information specific to the location to the victim. In optional step 114, additional information may be entered by the rescue worker. This additional information can include, for example, the victim's name, physical and mental condition, medical information, destination if any, and any instructions from the victim as to who to contact. In step 116, once the device or smartphone has obtained these pieces of information, the device uploads the identifying information, photograph, geographic information, and any other information entered by the rescue worker to the database. The database or website used to store the information can also be accessed for inquiries regarding victims and their geographic locations.

In step 118, the database is queried and information is supplied to a requester. Access to the database can be password controlled or some database can be available without password.

The identifying information, photograph, and geographic information can be uploaded together or separately as well as at the same time or at different times. The information upload can be performed by any electronic means, which can include though a global computer network, though a satellite communication network, wireless internet, or through a telephone network.

The database can be a computer-readable database containing information in electronic form which includes the images of the victims, geographical information describing both the initial (where found) and current positions of the victim, any proposed destination, and identifying information (if available) of the victim to whom the tag was issued. The database can also compile the information in the database of victims in a specific geographic region into a summary.

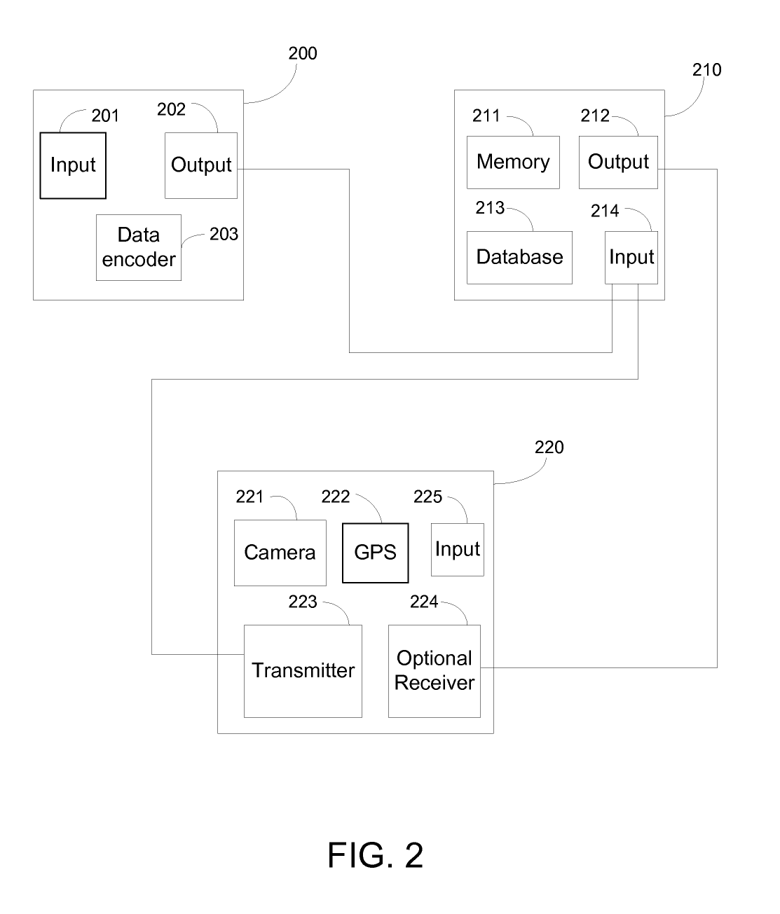

FIG. 2 depicts several devices connected through a network according to one embodiment of the present invention. An issuing device 200, a database computer 210, and a field use device 220 are connected over a network (not shown). The network is an example of one of the possible electronic means for transferring information from the devices 200, 220 to the computer 210 and vice versa. The issuing device 200 includes an input 201, an output 202 to link to the database computer 210, and a data encoder 203 for encoding identification data into, for example, a bar code, a QRS code, or an RFID. The computer 210 includes an input 214 and output 212 for linking to the issuing device 200 and field use device 220, respectively. The computer also has memory 211 for storing information uploaded from the issuing device 200 or the field use device 220 and a database 213 for accessing the information through a user interface, such as a website. The field use device 220 contains a camera 221 for taking photographs of the victim, a GPS 222 receiver for acquiring geographic coordinates to associate with the photographs, an input 225 for retrieving identifying information from, for example, bar codes, QRS codes, or RFIDs, a transmitter 223 for uploading the identifying information, photograph, and geographic coordinates to the computer 210, and an optional receiver 224 for confirming that the upload has been performed to the computer 210.

The field use device 220 can be a smart phone or some other electronic apparatus. A computer system, such as a website, can be programmed to receive first information regarding the issuance of a tag, which includes encoded machine readable identification information, permitting a rescue worker to store the first information in a database, to receive electronically from the person whom the tag was issued, second information including an image of the victim, geographical information describing the position of the victim, and identifying information of the person to whom the tag was issued, to decode the machine-readable identification information, to store in the database the second information, to associate in first information with the second information using the decoded identification information, and to output upon request a confirmation.

A multitude of field use devices 220 can send information to, and /or receive information from, the computer 210 simultaneously or at different times. Each field use device 220 can separately communicate with the website and/or database computer 210 to upload information, for example, of victims in various locations. A multitude of issuing devices 200 can also send information to the computer 210 simultaneously or at different times.

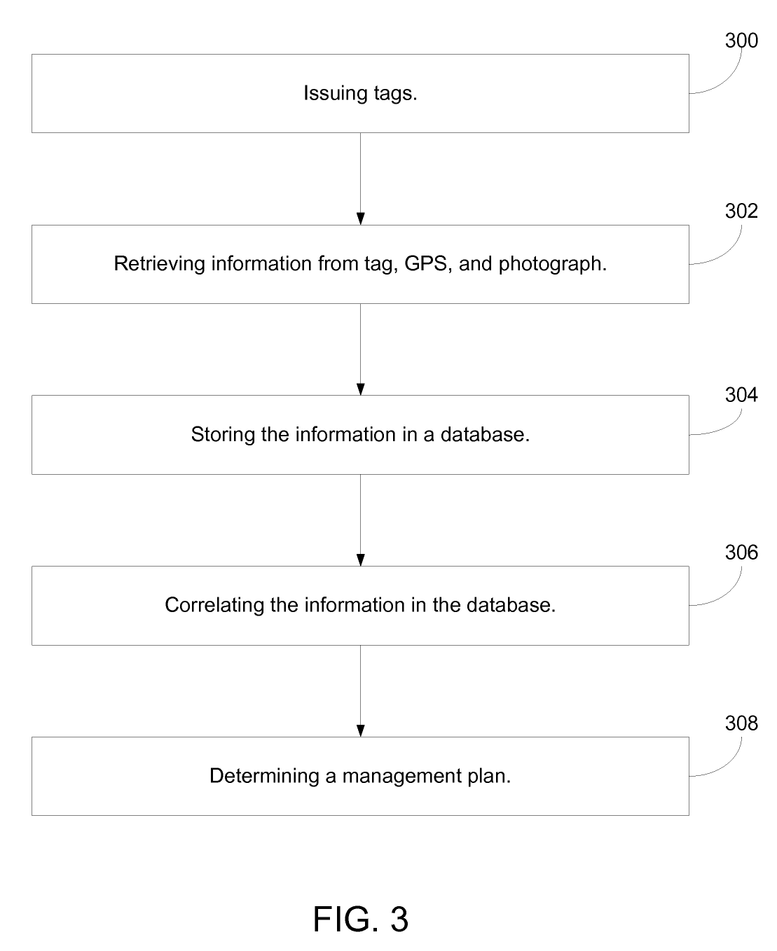

FIG. 3 shows a method of tracking victims according to an embodiment of the present invention. In step 300, a tag, which contains machine-readable coded information identifying the person to whom the tag is issued, is given to a rescue worker. Information concerning the issuance of the tag is uploaded to a database. In step 302, information is obtained from the tag, which is attached to a victim, and a photograph of the victim and GPS coordinates are acquired. The GPS coordinates are associated with the photograph. In step 304, the tag information, photograph, and GPS coordinates are stored in the database. In step 306, the related information in the database is correlated. In step 308, a management plan of the information in the database is determined. This plan governs the way the information is stored and displayed to users accessing the database for information. The database may be used for additional purposes during the duration of the disaster such as: 1) determining which geographical areas and structures have already been searched and which areas and structures have not been searched yet (this information would be derived from the overall set of GPS locations of victims—areas which possibly have not yet been searched would be conspicuous from the lack of any victim GPS coordinates within those areas), 3) allocation of search and medical personnel on a real-time basis to reduce the average time to access victims, 3) optimizing future search procedures and patterns for future disasters, and 4) documentation of the performance of the search and rescue teams, to determine successes and failures, and determine any training requirements for these teams prior to future disasters.

When the victim is unhurt, the tag may be handed to victim or destroyed so that it is not reissued. It is preferred for the unhurt victim to keep the tag attached, in case injuries (e.g., concussions, internal bleeding, inhalation of toxic substances, etc.) that may not be apparent during the initial period of interaction with the rescue worker may require later medical attention.

A preferred method or apparatus of the present invention has many novel aspects, and because the invention can be embodied in different methods or apparatuses for different purposes, not every aspect need be present in every embodiment. Moreover, many of the aspects of the described embodiments may be separately patentable. The invention has broad applicability and can provide many benefits as described and shown in the examples above. The embodiments will vary greatly depending upon the specific application, and not every embodiment will provide all of the benefits and meet all of the objectives that are achievable by the invention. The term “bar-code” may also include microchips or other types of computer-readable labeling media.

It should be recognized that embodiments of the present invention can be implemented via computer hardware, a combination of both hardware and software, or by computer instructions stored in a non-transitory computer-readable memory. The methods can be implemented in computer programs using standard programming techniques—including a non-transitory computer-readable storage medium configured with a computer program, where the storage medium so configured causes a computer to operate in a specific and predefined manner—according to the methods and figures described in this Specification. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits programmed for that purpose.

Further, methodologies may be implemented in any type of computing platform, including but not limited to, personal computers, mini-computers, main-frames, workstations, networked or distributed computing environments. Aspects of the present invention may be implemented in machine readable code stored on a non-transitory storage medium or device, whether removable or integral to the computing platform, such as a hard disc, optical read and/or write storage mediums, RAM, ROM, and the like, so that it is readable by a programmable computer, for configuring and operating the computer when the storage media or device is read by the computer to perform the procedures described herein. Moreover, machine-readable code, or portions thereof, may be transmitted over a wired or wireless network. The invention described herein includes these and other various types of non- transitory computer-readable storage media when such media contain instructions or programs for implementing the steps described above in conjunction with a microprocessor or other data processor. The invention also includes the computer itself when programmed according to the methods and techniques described herein.

Computer programs can be applied to input data to perform the functions described herein and thereby transform the input data to generate output data. The output information is applied to one or more output devices such as a display monitor.

In the following discussion and in the claims, the terms “including” and “comprising” are used in an open-ended fashion, and thus should be interpreted to mean “including, but not limited to . . . .” To the extent that any term is not specially defined in this specification, the intent is that the term is to be given its plain and ordinary meaning. The accompanying drawings are intended to aid in understanding the present invention and, unless otherwise indicated, are not drawn to scale.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method of tracking victims of natural or man-made disasters, comprising:
issuing to a person a tag including machine-readable coded information identifying the person to whom the tag is issued;
attaching by the person the tag to the victim when the victim is first located after the occurrence of the disaster;
after the tag is attached to a victim, receiving electronically from the person to whom the tag was issued an image of the victim, geographical information describing the position of the victim when first located, and identifying information of the person to whom the tag was issued;
storing in a computer readable database the information an image of the victim, geographical information describing the initial current locations of the victim when found, and identifying information of the person to whom the tag was issued.

2. The method of claim 1 further comprising compiling from the database summary information regarding victims in a geographic region.

3. The method of claim 1 further comprising accessing the database by someone other than the person to whom the tag was issued to confirm that the information concerning the victim was uploaded to the data base.

4. The method of claim 1 in which the machine-readable coded information is encoded in a bar code or a QRS code.

5. The method of claim 1 in which receiving electronically from the person to whom the tag was issued includes receiving the information through a global computer network, through a telephone network.

6. A system for tracking of tracking alive and deceased victims of disasters, comprising:
receiving by a user a tag to be attached to a victim, the tag including a machine-readable unique identifier, the unique identifier and user information being stored in a database;
attaching the tag to a victim;
scanning the tag with a device capable or reading the machine-readable unique identifier;
causing the machine-readable unique identifier from the tag and additional information not recorded on the tag to be uploaded to the database to be associated with the user information.

7. The system of claim 6 in which causing the machine-readable unique identifier from the tag and additional information not recorded on the tag to be uploaded to the database includes causing information generated by the device to be uploaded.

8. The system of claim 7 in which information generated by the device includes location information and/or device identification information.

9. The system of claim 6 further comprising photographing the victim and in which causing the machine-readable unique identifier from the tag and additional information not recorded on the tag to be uploaded to the database includes causing the photograph to be uploaded.

10. The system of claim 6 further comprising manually entering information regarding the victim and in which causing the machine-readable unique identifier from the tag and additional information not recorded on the tag to be uploaded to the database includes causing the manually entered information to be uploaded.

11. The system of claim 10 in which causing the manually entered information to be uploaded includes causing information about the sex and/or the age of the victim.

12. A system for tracking alive and deceased victims of disasters, comprising:
issuing to a user a tag to be a victim, the tag including a machine-readable unique identifier, the unique identifier and user information being stored in a database;
receiving uploaded information after the tag is attached to the victim, the uploaded information being obtained from a scan of tag with a device capable of reading the tag and the uploaded information including the unique identifier;
receiving additional uploaded information not recorded on the tag;
associating the uploaded information and the additional uploaded information with the user.

13. The system of claim 12 in which receiving additional uploaded information includes receiving information generated by the device.

14. The system of claim 13 in which information generated by the device includes location information and/or device identification information.

15. The system of claim 12 in which receiving additional uploaded information includes one or more photographs of the tagged victim.

16. The system of claim 12 in which receiving additional uploaded information includes receiving additional information manually entered into the device.

17. The system of claim 16 in which receiving additional information manually entered into the device includes receiving information about the sex and/or the age of the victim.

18. A computer system including a computer memory storing computer instruction to:
receive first information regarding the issuance of a tag intended for labeling a victim of a natural or man-made disaster, the tag including encoded machine readable identification information;
store the first information in a database;
receive electronically from the person to whom the tag was issued second information including an image of the victim, geographical information describing the position of the victim, and identifying information of the person to whom the tag was issued;
decode the machine-readable identification information;
store in the database the second information;
associate the first information with the second information using the decoded identification information; and
output upon request information stored in the database.

19. The computer system of claim 18, wherein the output of information from the database may be restricted to a subset of the information stored in the database.

20. The computer system of claim 18, wherein the output of information from the database may be restricted to certain persons, such as family members and loved ones of individual victims.
